(19) United States
(12) Patent Application Publication
(10) Pub. No.: US 2026/0223223 A1
(43) Pub. Date: Jul. 30, 2026

(54) DEVICE AND METHOD FOR RECONFIGURING MULTI LINK IN WIRELESS LOCAL AREA NETWORK

(71) Applicant: FRONTSIDE LLC, Seoul (KR)

(72) Inventor: Jeong Soo LEE, Gyeonggi-do (KR)

(21) Appl. No.: 19/145,986

(22) PCT Filed: Dec. 28, 2023
(86) PCT No.: PCT/KR2023/021867

§ 371 Date: Jul. 7, 2025

(30) Foreign Application Priority Data
Jan. 12, 2023 (KR) 10-2023-0004475
Feb. 6, 2023 (KR) 10-2023-0015798
Apr. 20, 2023 (KR) 10-2023-0051716
Aug. 22, 2023 (KR) 10-2023-0109466

(51) Int. Cl. H04W 76/15; H04W 76/19

(52) U.S. Cl. CPC H04W 76/15; H04W 76/19

(57) ABSTRACT

A method for reconfiguring multi-link (ML) to add and delete links dynamically without requiring association between an access point (AP) multi-link device (MLD) and a non-AP MLD in a wireless local area network is provided. The non-AP MLD transmits a ML reconfiguration request frame for requesting switch link. The ML reconfiguration request frame includes first link information indicating a first link that is requested to be added and second link information indicating a second link that is requested to be deleted.

### TECHNICAL FIELD

The present disclosure relates to a wireless local area network (WLAN), and more particularly, to a method for reconfiguring multi-link in the WLAN and a device using the same.

### BACKGROUND ART

A wireless local area network (WLAN) may be formed by one or more access points (APs) that provide a shared wireless communication medium for use by a number of client devices also referred to as stations (STAs).

Orthogonal frequency division multiple access (OFDMA) is a multiple access scheme where different subsets of subcarriers are allocated to different users, and this scheme allows simultaneous data transmission to or from one or more users.

A physical layer protocol data unit (PPDU) is a data unit (or data packet) to carry various information in the WLAN. In OFDMA, users are allocated different subsets of subcarriers that can change from one PPDU to the next. Using OFDMA, an AP may allocate different RUs for STAs. The AP can simultaneously transmit various formats of PPDUs to multiple STAs.

Roaming (may be called as handover or handoff) is the process of transferring an ongoing call or data session from one AP (or one channel) to another AP (or another channel). It may be the process of transferring data control responsibility from one AP to another AP without loss or interruption of service.

### DISCLOSURE OF INVENTION

### Technical Problem

The present disclosure provides a method for reconfiguring multi-link (ML) in a wireless local area network.

The present disclosure further provides a device for reconfiguring ML in a wireless local area network.

### Solution to Problem

In an aspect, a method for reconfiguring multi-link (ML) to add and delete links dynamically without requiring association between an access point (AP) multi-link device (MLD) and a non-AP MLD in a wireless local area network is provided. The method performed by the non-AP MLD includes transmitting a ML reconfiguration request frame for requesting switch link from a non-AP station (STA) affiliated with the non-AP MLD to an AP affiliated with the AP MLD, and receiving a ML reconfiguration response frame from the AP MLD in response to the ML reconfiguration request frame. The ML reconfiguration request frame includes first link information indicating a first link that is requested to be added and second link information indicating a second link that is requested to be deleted.

The first link information can include a link ID subfield and a reconfiguration type subfield, the link ID subfield indicating the first link that is requested to be added, the reconfiguration type subfield indicating adding link, and the second link information can include a link ID subfield and a reconfiguration type subfield, the link ID subfield indicating the second link that is requested to be deleted, the reconfiguration type subfield indicating deleting link.

The first link information can further include a station address subfield indicating the non-AP STA affiliated with the non-AP MLD, and the second link information can further include a station address subfield indicating the non-AP STA affiliated with the non-AP MLD.

In another aspect, a device operating as a non-access point (AP) multi-link device (MLD) for reconfiguring multi-link (ML) to add and delete links dynamically without requiring association between an AP MLD and the non-AP MLD in a wireless local area network is provided. The device includes a processor, and a memory operatively coupled with the processor and configured to store instructions that, when executed by the processor, cause the device to perform functions. The functions include transmitting a ML reconfiguration request frame for requesting switch link from a non-AP station (STA) affiliated with the non-AP MLD to an AP affiliated with the AP MLD, and receiving a ML reconfiguration response frame from the AP MLD in response to the ML reconfiguration request frame. The ML reconfiguration request frame includes first link information indicating a first link that is requested to be added and second link information indicating a second link that is requested to be deleted.

### Advantageous Effects of Invention

As new WLAN communication protocols enable enhanced features, seamless roaming procedures are provided.

### BRIEF DESCRIPTION OF DRAWINGS

FIG. 1 shows a block diagram of an example wireless communication network.

FIG. 2 shows a block diagram of an example wireless communication device.

FIG. 3 shows an example of UL MU transmission.

FIG. 4 shows an example of multi-link operation.

FIG. 5 shows an example of an enhanced multi-link single radio operation.

FIG. 6 shows an example of contents in EML Operating Mode Notification frame.

FIG. 7 shows an example of roaming in WLAN.

FIG. 8 shows an example of ML operation according to an embodiment of the present disclosure.

FIG. 9 shows an example of ML operation when an AP is out of range.

FIG. 10 shows an example of ML operation when the STA MLD moves.

FIG. 11 shows an example of ML operation when the STA MLD further moves.

FIG. 12 shows an example of MPDU forwarding during a roaming.

FIG. 13 shows an example of packet format for encapsulated MPDU forwarding.

FIG. 14 shows an example of packet loss in quasi-seamless roaming mode.

FIG. 15 shows an example of Reduced Neighbor Report element format according to an embodiment of the present disclosure.

FIG. 16 shows an example of ML reconfiguration according to an embodiment of the present disclosure.

FIG. 17 shows an example of ML Reconfiguration Request frame according to an embodiment of the present disclosure.

FIG. 18 shows an example of ML setup procedure.

FIG. 19 shows an example of non-co-located AP MLD.

FIG. 20 shows first step for ML roaming procedure according to an embodiment of the present disclosure.

FIG. 21 shows second step for ML roaming procedure according to an embodiment of the present disclosure.

FIG. 22 shows third step for ML roaming procedure according to an embodiment of the present disclosure.

FIG. 23 shows first example of group-addressed frame delivery according to an embodiment of the present disclosure.

FIG. 24 shows second example of group-addressed frame delivery according to an embodiment of the present disclosure.

FIG. 25 shows third example of group-addressed frame delivery according to an embodiment of the present disclosure.

### MODE FOR THE INVENTION

The following description is directed to certain implementations for the purposes of describing innovative aspects of this disclosure. However, a person having ordinary skill in the art will readily recognize that the teachings herein can be applied in a multitude of different ways. The described implementations can be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described implementations can be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), single-user (SU) multiple-input multiple-output (MIMO) and multi-user (MU) MIMO. The described implementations also can be implemented using other wireless communication protocols or RF signals suitable for use in one or more of a wireless personal area network (WPAN), a wireless local area network (WLAN), a wireless wide area network (WWAN), or an internet of things (IOT) network.

OFDMA is an OFDM-based multiple access scheme where different subsets of subcarriers are allocated to different users, and this scheme allows simultaneous data transmission to or from one or more users. In OFDMA, users are allocated different subsets of subcarriers that can change from one PPDU to the next. Similar to OFDM, OFDMA employs multiple subcarriers, but the subcarriers are divided into several groups where each group is referred to as a resource unit (RU).

A physical layer protocol data unit (PPDU) may span one or more subchannels and may include a preamble portion and a data portion. Signaling refers to control fields or information in the preamble portion that can be used by a wireless communication device to interpret another field or portion of the preamble portion or the data portion of the PPDU. A wireless channel may be formed from multiple subchannels. A subchannel may include a set of subcarriers. Portions of the wireless channel bandwidth can be divided or grouped to form different resource units (RUs). An RU may be a unit for resource allocation and may include one or more subcarriers. Among other things, a preamble portion of a PPDU may include signaling to indicate which RUs are allocated to different devices. Other types of signaling include indicators regarding which subchannels include further signaling or which subchannels may be punctured. There are several formats of PPDUs (and related structures) defined for current wireless communication protocols. As new wireless communication protocols enable enhanced features, new preamble designs are needed support signaling regarding features and resource allocations. Furthermore, it desirable to define a new preamble signaling protocol that can support future wireless communication protocols.

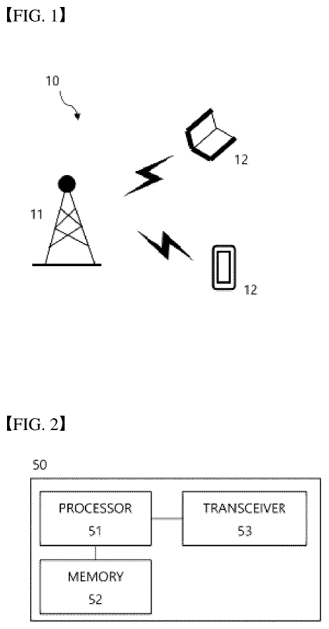

FIG. 1 shows a block diagram of an example wireless communication network.

According to some aspects, the wireless communication network 10 can be an example of a wireless local area network (WLAN) such as a Wi-Fi network (and will hereinafter be referred to as WLAN 10). For example, the WLAN 10 can be a network implementing at least one of the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). The WLAN 10 may include numerous wireless communication devices such as an access point (AP) 11 and multiple stations (STAs) 12. While only one AP 11 is shown, the WLAN network 10 also can include multiple APs.

Each of the STAs 12 also may be referred to as a mobile station (MS), a mobile device, a mobile handset, a wireless handset, an access terminal (AT), a user equipment (UE), a subscriber station (SS), or a subscriber unit, among other possibilities. The STAs 12 may represent various devices such as mobile phones, personal digital assistant (PDAs), other handheld devices, netbooks, notebook computers, tablet computers, laptops, display devices (for example, TVs, computer monitors, navigation systems, among others), music or other audio or stereo devices, remote control devices (“remotes”), printers, kitchen or other household appliances, key fobs (for example, for passive keyless entry and start (PKES) systems), among other possibilities.

A single AP 11 and an associated set of STAs 12 may be referred to as a basic service set (BSS), which is managed by the respective AP 11. The BSS may be identified to users by a service set identifier (SSID), as well as to other devices by a basic service set identifier (BSSID), which may be a medium access control (MAC) address of the AP 11. The AP 11 periodically broadcasts beacon frames (“beacons”) including the BSSID to enable any STAs 12 within wireless range of the AP 11 to “associate” or re-associate with the AP 11 to establish a respective communication link (hereinafter also referred to as a “Wi-Fi link”), or to maintain a communication link, with the AP 11. For example, the beacons can include an identification of a primary channel used by the respective AP 11 as well as a timing synchronization function for establishing or maintaining timing synchronization with the AP 11. The AP 11 may provide access to external networks to various STAs 12 in the WLAN via respective communication link.

To establish a communication link with an AP 11, each of the STAs 12 is configured to perform passive or active scanning operations (“scans”) on frequency channels in one or more frequency bands (for example, the 2.4 GHZ, 5 GHZ, 6 GHz or 60 GHz bands). To perform passive scanning, a STA 12 listens for beacons, which are transmitted by respective APs 11 at a periodic time interval referred to as the target beacon transmission time (TBTT) (measured in time units (TUs) where one TU may be equal to 1024 microseconds (μs)). To perform active scanning, a STA 12 generates and sequentially transmits probe requests on each channel to be scanned and listens for probe responses from APs 11. Each STA 12 may be configured to identify or select an AP 11 with which to associate based on the scanning information obtained through the passive or active scans, and to perform authentication and association operations to establish a communication link with the selected AP 11. The AP 11 assigns an association identifier (AID) to the STA 12 at the culmination of the association operations, which the AP 11 uses to track the STA 104.

In some cases, STAs 12 may form networks without APs 11 or other equipment other than the STA. One example of such a network is an ad hoc network (or wireless ad hoc network). Ad hoc networks may alternatively be referred to as mesh networks or peer-to-peer (P2P) networks. In some cases, ad hoc networks may be implemented within a larger wireless network such as the WLAN 10. In such implementations, while the STAs 12 may be capable of communicating with each other through the AP 11 using communication links, STAs 12 also can communicate directly with each other via direct wireless links. Additionally, two STAs 12 may communicate via a direct communication link regardless of whether both STAs 12 are associated with and served by the same AP 11. In such an ad hoc system, one or more of the STAs 12 may assume the role filled by the AP 11 in a BSS. Such a STA may be referred to as a group owner (GO) and may coordinate transmissions within the ad hoc network.

The AP 11 and STAs 12 may function and communicate (via the respective communication links) according to the IEEE 802.11 family of wireless communication protocol standards (such as that defined by the IEEE 802.11-2016 specification or amendments thereof including, but not limited to, 802.11ah, 802.11ad, 802.11ay, 802.11ax, 802.11az, 802.11ba and 802.11be). These standards define the WLAN radio and baseband protocols for the PHY and medium access control (MAC) layers. The AP 11 and STAs 12 transmit and receive wireless communications (hereinafter also referred to as “Wi-Fi communications”) to and from one another in the form of PPDUs. The AP 11 and STAs 12 in the WLAN 10 may transmit PPDUs over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the AP 11 and STAs 12 described herein also may communicate in other frequency bands, such as the 6 GHz band, which may support both licensed and unlicensed communications. The AP 11 and STAs 12 also can be configured to communicate over other frequency bands such as shared licensed frequency bands, where multiple operators may have a license to operate in the same or overlapping frequency band or bands.

Each of the frequency bands may include multiple channels (which may be used as subchannels of a larger bandwidth channel). For example, PPDUs conforming to the IEEE 802.11n, 802.11ac and 802.11ax standard may be transmitted over the 2.4 and 5 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 or 320 MHz by bonding together multiple 20 MHz channels (which may be referred to as subchannels).

Each PPDU is a composite structure that includes a PHY preamble and a payload in the form of a PHY service data unit (PSDU). The information provided in the preamble may be used by a receiving device to decode the subsequent data in the PSDU. In instances in which PPDUs are transmitted over a bonded channel, the preamble fields may be duplicated and transmitted in each of the multiple component channels. The PHY preamble may include both a first portion (or “legacy preamble”) and a second portion (or “non-legacy preamble”). The first portion may be used for packet detection, automatic gain control and channel estimation, among other uses. The first portion also may generally be used to maintain compatibility with legacy devices as well as non-legacy devices. The format of, coding of, and information provided in the second portion of the preamble is based on the particular IEEE 802.11 protocol to be used to transmit the payload.

Uplink (UL) means that the signal (or message or PPDU) is transmitted by a STA to an AP, and downlink (DL) means that the signal (or message or PPDU) is transmitted by the AP to one or more STAs.

FIG. 2 shows a block diagram of an example wireless communication device.

In some implementations, the wireless communication device 50 can be an example of a device for use in a STA such as one of the STAs 12 described above with reference to FIG. 1. In some implementations, the wireless communication device 50 can be an example of a device for use in an AP such as the AP 11 described above with reference to FIG. 1. The wireless communication device 50 is capable of transmitting (or outputting for transmission) and receiving wireless communications (for example, in the form of wireless packets). For example, the wireless communication device can be configured to transmit and receive packets in the form of PPDUs and/or medium access control (MAC) protocol data units (MPDUs) conforming to an IEEE 802.11 wireless communication protocol standard, such as that defined by the IEEE 802.11-2016 specification or amendments thereof including, but not limited to, 802.11ah, 802.11ad, 802.11ay, 802.11ax, 802.11az, 802.11ba and 802.11be.

The wireless communication device 50 can be, or can include, a chip, system on chip (SoC), chipset, package or device that includes one or more processor 51. The processor 51 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 51 processes information received through a transceiver 53, and processes information to be output through the transceiver 53 through the wireless medium. For example, the processor 806 may implement a physical (PHY) layer and/or a MAC layer configured to perform various operations related to the generation and transmission of PPDUs, MPDUs, frames or packets.

A memory 52 can include tangible storage media such as random-access memory (RAM) or read-only memory (ROM), or combinations thereof. The memory 808 also can store non-transitory processor- or computer-executable software code containing instructions that, when executed by the processor 51, cause the wireless communication device 50 to perform various operations described herein for wireless communication, including the generation, transmission, reception and interpretation of PPDUs, MPDUs, frames or packets. For example, various functions of components disclosed herein, or various blocks or steps of a method, operation, process or algorithm disclosed herein, can be implemented as one or more modules of one or more computer programs.

The transceiver 53 generally includes at least one radio frequency (RF) transmitter (or “transmitter chain”) for transmitting radio signals and at least one RF receiver (or “receiver chain”) for receiving radio signals. For example, the RF transmitters and receivers may include various DSP circuitry including at least one power amplifier (PA) and at least one low-noise amplifier (LNA), respectively. The RF transmitters and receivers may, in turn, be coupled to one or more antennas. For example, in some implementations, the wireless communication device 50 can include, or be coupled with, multiple transmit antennas (each with a corresponding transmit chain) and multiple receive antennas (each with a corresponding receive chain).

Very high throughput (VHT) is used to represent IEEE 802.11ac, high efficiency (HE) is used to represent IEEE 802.11ax, extremely high throughput (EHT) is used to represent IEEE 802.11be. EHT STA may be used to represent a STA supporting at least EHT. EHT STA can further support VHT and/or HE.

Ultra High Reliability (UHR) is used to represent any later (post-EHT) version of a new wireless communication protocol conforming to a future IEEE 802.11 wireless communication protocol standard or other standard, and is for illustration purpose only. ‘UHR’ may be referred to as other terms, for example, Ultra Low Latency (ULL), High Reliability (HR), etc. The UHR PPDU may support future amendments to the IEEE 802.11 wireless communication standard.

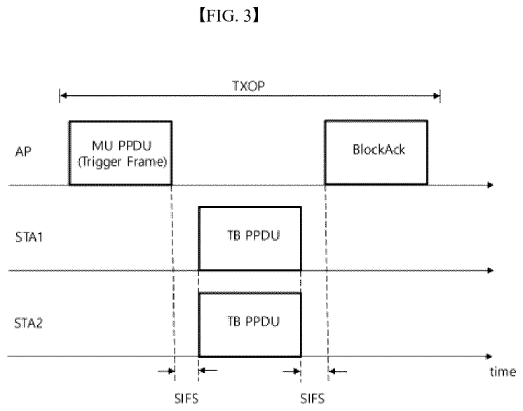

FIG. 3 shows an example of UL MU transmission.

UL MU operation allows an AP to solicit simultaneous immediate response frames from one or more STAs.

The AP may send a trigger frame to one or more STAs (for example, STA1 and STA2). The trigger frame may be sent as MU PPDU (for example, HE MU PPDU or EHT MU PPDU). The STA1 and STA2 may send response PDUs (for example, HE TB PPDU or EHT TB PPDU) in response to the trigger frame. The interframe space between a PPDU that contains a triggering frame and the TB PPDU is a Short Interframe Space (SIFS). The AP sends an Ack or BlockAck frame acknowledging the one or more TB PPDUs to the response STAs (for example, STA1 and STA2).

The trigger frame allocates resources for and solicits one or more PPDU transmissions. The trigger frame also carries other information required by the responding STA to send a TB PPDU or a non-HT PPDU. The trigger frame may be sent as various types such as a basic trigger frame, multi-user request to send (MU-RTS) frame, multi-user block ack request (MU-BAR) frame, Beamforming Report Poll (BFRP) Trigger frame, etc.

The trigger frame may include a UL bandwidth field, an CS required field, one or more STA IDs and one or more resource unit (RU) Allocation field. The UL bandwidth field indicates the bandwidth of the response PPDU. The CS required field indicate whether the response STAs are required to use energy detection (ED) to sense the medium and to consider the medium state and the network allocation vector (NAV) in determining whether or not to respond. The one or more STA IDs identifies the one or more response STAs. The RU Allocation subfield indicates RU allocation for the response PPDU.

A NAV is an indicator, maintained by each STA, of time periods when transmission onto the wireless medium (WM) is not initiated by the STA regardless of whether the STA's clear channel assessment (CCA) function senses that the WM is busy. Transmission opportunity (TXOP) is an interval of time during which a particular STA has the right to initiate frame exchange sequences onto the WM.

A WLAN device classify a received PPDU as an inter-PPDU if (i) the received PPDU is transmitted by an AP which is not associated with the WLAN device, (ii) the received PPDU's BSS is not the BSS of the WLAN device, or (iii) the received PPDU is a downlink MU PPDU and the WLAN device is an AP.

A WLAN device classify a received PPDU as an intra-PPDU if (i) the received PPDU is transmitted by an AP which is associated with the WLAN device, (ii) the received PPDU's BSS is the BSS of the WLAN device, or (iii) the received PPDU is a downlink MU PPDU and the WLAN device is an AP.

Timing synchronization function (TSF) keeps TSF timers for all stations in the same BSS synchronized. STAs can maintain a local TSF timer. Each STA can maintain a TSF timer with modulus 264 counting in increments of microseconds. The AP is the timing master for the TSF. The AP can periodically transmit beacon frames which contain the value of the AP's TSF timer in order to synchronize the TSF timers of other STAs in a BSS. A receiving STA can accept the timing information in the beacon frames and can update the receiving STA's TSF timer. If the receiving STA's TSF timer is different from the timestamp in the received beacon frame, the receiving STA can set its local TSF timer to the received timestamp value.

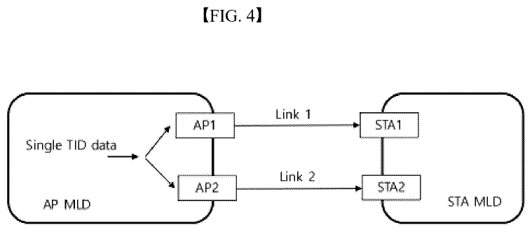

FIG. 4 shows an example of multi-link operation.

In order to optimize the system spectrum utilization and achieve better throughput performance, the IEEE 802.11be has defined multi-link operation (MLO) to support sending data frames concurrently on multiple links. MLO allows the users to enjoy the multilink benefits unavailable for a simple noncontiguous wide spectrum on a single link, such as asynchronous channel access and enhanced power save. The MLO can aggregate a various number of links of different widths. For example, Link1 has a bandwidth of 160 MHz and Link2 has a bandwidth of 40 MHz. Despite having multiple PHY/MAC interfaces, MLD has a single MAC address and uses this MAC address as its own identity. MLO enables frame transmission and retransmission on any link regardless of the link of the initial transmission of the frame.

A multi-link device (MLD) may be a logical entity that is capable of supporting more than one affiliated STA and can operate using one or more affiliated STAs, and that presents one medium access control (MAC) data service and a single MAC-service access point (SAP) to the logical link control (LLC) sublayer. An affiliated AP is an affiliated STA that is an AP STA and the corresponding MLD is an AP MLD. An affiliated STA is a STA, which can be an AP STA or non-AP STA, that provides linkspecific, lower MAC and physical layer (PHY) services within an MLD.

An enabled link is a setup link of a non-AP MLD to which at least one traffic identifier (TID) is mapped either in downlink or in uplink. A disabled link is a setup link of a non-AP MLD to which no TID is mapped neither in downlink nor in uplink. A TID is any of the identifiers usable by higher layer entities to distinguish MAC service data units (MSDUs) to MAC entities that support quality of service (QoS) within the MAC data service.

If an MLD implements multiple radios and uses these multiple radios concurrently for the MLO, these devices are defined as multilink multiradio (MLMR) MLD. If an MLD only implements single radio and still wants to operate multiple links, then these devices are called multilink single-radio (MLSR) MLD.

An AP MLD may include multiple APs each capable of communicating on multiple communication links and may establish a BSS on the multiple communication links. A STA MLD may include multiple STAs capable of communicating with other devices (such as an AP MLD) on multiple communication links. If congestion on a first communication link is above a certain level, the MLDs may switch from communicating on the first communication link to communicating on a second communication link. In some implementations, associating with one another on one communication link allows the MLDs to use the same association configuration, encryption keys, and other ML communication parameters when communicating on one or more of the other communication links associated with the MLDs.

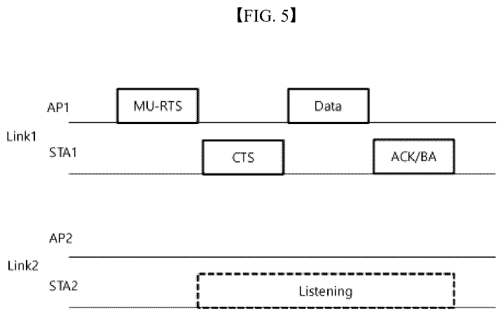

FIG. 5 shows an example of an enhanced multi-link single radio operation.

Enhanced multi-link single radio (EMLSR) operation is a mode of operation that allows a non-AP MLD with multiple receive chains to listen on a set of enabled links when the corresponding STAs affiliated with the non-AP MLD are in the awake state for an initial Control frame (for example, a trigger frame sent by an AP affiliated with an AP MLD, followed by frame exchanges on the link on which the initial Control frame was received).

Assuming that AP MLD includes AP1 and AP2 as affiliated APs, and STA MLD includes STA1 and STA2 as affiliated STAs. When an AP MLD intends to conduct EMLSR operation with an EMLSR STA MLD, each AP within the AP MLD tries to access the corresponding band/channel by running EDCA function independently. In this example, AP1 of the AP MLD is operating on the 6 GHz band (Link1) and AP2 is operating on the 5 GHz band (Link2). If the EDCA function completes the backoff procedure, the corresponding AP starts frame exchange procedure by sending Initial Control Frame (ICF). In this example, AP1 on the 6 GHz band completes backoff, so AP1 sends a MU-RTS frame to start EMLSR operation. When AP1 on the 6 GHz band sends out MU-RTS, STA1 of STA MLD receives the MU-RTS and understands the following DL data transmission which will be carried out on the 6 GHz band.

EMLSR operation can provide throughput enhancement and latency reduction similar to that of concurrent dual-radio MLDs. EMLSR operation enables a wireless device having a single radio to receive data using multiple channels/links. When a wireless device is operating in the EMLSR mode with an AP that supports the EMLSR mode, the device can listen on the enabled links by leaving its affiliated wireless STAs corresponding to those links in an awake state (“listening mode”). The listening operation can include performing clear channel assessment (CCA) and receiving an initial control frame of a frame exchange sequence that is initiated by an AP MLD.

A non-AP MLD may operate in the EMLSR mode on a specified set of the enabled links between the non-AP MLD and its associated AP MLD. The specified set of the enabled links in which the EMLSR mode is applied is called EMLSR links. The EMLSR links can be indicated in the EMLSR Link Bitmap subfield of the EML Control field of the EML Operating Mode Notification frame by setting the bit positions of the EMLSR Link Bitmap subfield to 1. For the EMLSR mode enabled in a single-radio non-AP MLD, the STA(s) affiliated with the non-AP MLD that operates on the link(s) that corresponds to the bit position(s) of the EMLSR Link Bitmap subfield set to 0 may be in doze state if a STA affiliated with the non-AP MLD that operates on one of the EMLSR links is in awake state.

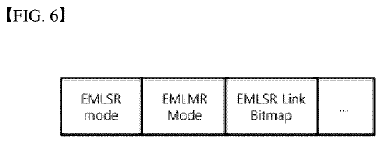

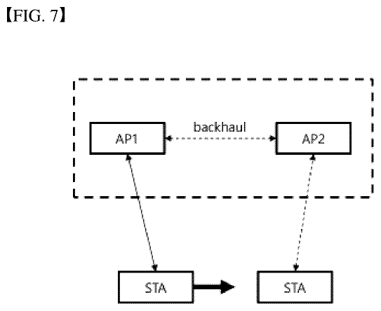

FIG. 6 shows an example of contents in EML Operating Mode Notification frame.

The EML Operating Mode Notification frame is used to indicate that a non-AP MLD with which the transmitting STA is affiliated is changing its EML operation.

A non-AP MLD that supports EMLSR operation sets the EMLSR Mode subfield to 1 to indicate that the non-AP MLD operates in EMLSR mode and to 0 to indicate that the non-AP MLD does not operate in EMLSR mode. The EMLSR Mode subfield is set to 0 if the enhanced multi-link multi-radio (EMLMR) Mode subfield is set to 1. An AP MLD that receives an EML Operating Mode Notification frame from a STA affiliated with a non-AP MLD sets the EMLSR Mode subfield of the EML Operating Mode Notification frame that is sent in response to the value obtained from the received EML Operating Mode Notification frame.

The EMLSR Link Bitmap subfield indicates the subset of the enabled links that is used by the non-AP MLD in the EMLSR mode. The bit position i of the EMLSR Link Bitmap subfield corresponds to the link with the Link ID equal to i and is set to 1 to indicate that the link is used by the non-AP MLD for the EMLSR mode and is a member of the EMLSR links; otherwise the bit position is set to 0.

When a non-AP MLD intends to operate in the EMLSR mode on the EMLSR links, a STA affiliated with the non-AP MLD can transmit an EML Operating Mode Notification frame with the EMLSR Mode subfield of the EML Control field of the frame set to 1 to an AP affiliated with an AP MLD. An AP affiliated with the AP MLD that received the EML Operating Mode Notification frame from the STA affiliated with the non-AP MLD can transmit an EML Operating Mode Notification frame to one of the STAs affiliated with the non-AP MLD within a timeout interval.

When a non-AP MLD is operating in the EMLSR mode with an AP MLD supporting the EMLSR mode, the non-AP MLD can be able to listen on the EMLSR links, by having its affiliated STA(s) corresponding to those links in awake state. The listening operation includes CCA and receiving the initial Control frame of frame exchanges that is initiated by the AP MLD. An AP affiliated with the AP MLD that initiates frame exchanges with the non-AP MLD on one of the EMLSR links can begin the frame exchanges by transmitting the initial Control frame to the non-AP MLD. The initial Control frame may be a MU-RTS Trigger frame or a BSRP Trigger frame. A STA affiliated with a non-AP MLD that is in the listening operation and that receives an MU-RTS Trigger Frame or BSRP Trigger frame addressed to it can respond except when the frame exchanges initiated by the initial Control frame on one of the EMLSR links overlaps with group addressed frame transmissions on the other EMLSR link where the non-AP STA intends to receive the group addressed frames.

After receiving the initial Control frame for initiating frame exchanges and transmitting an immediate response frame as a response to the initial Control frame, a STA affiliated with the non-AP MLD that was listening on the corresponding link can be able to transmit or receive frames on the link in which the initial Control frame was received and cannot transmit or receive on the other EMLSR link(s) until the end of the frame exchanges. The STA affiliated with the non-AP MLD can be capable of receiving a PPDU that is sent using more than one spatial stream on the link in which the initial Control frame was received a SIFS after the end of its response frame transmission solicited by the initial Control frame. During the frame exchanges, the other AP(s) affiliated with the AP MLD may not transmit frames to the other STA(s) affiliated with the non-AP MLD on the other EMLSR link(s).

The AP affiliated with the AP MLD can transmit before the TXNAV timer expires another initial Control frame addressed to the STA affiliated with the non-AP MLD if the AP intends to continue the frame exchanges with the STA and did not receive the response frame from this STA for the most recently transmitted frame that requires an immediate response after a SIFS.

Only one STA affiliated with the non-AP MLD that is operating on one of the EMLSR links may initiate frame exchanges with the AP MLD.

Transmission opportunity (TXOP) is an interval of time during which a particular STA has the right to initiate frame exchange sequences onto a wireless medium (WM) or a channel. A TXOP holder is a STA that has either been granted a TXOP or successfully contended for a TXOP. A TXOP responder is a STA that transmits a frame in response to a frame received from a TXOP holder during a frame exchange sequence, but that does not acquire a TXOP in the process.

FIG. 7 shows an example of roaming in WLAN.

Roaming (may be called as handover or handoff) is the process of transferring an ongoing call or data session from one AP (or one channel) to another AP (or another channel). It may be the process of transferring data control responsibility from one AP to another AP without loss or interruption of service.

When the link with AP1 deteriorates and the signal with AP2 grows stronger, the STA roams to AP2 (another case is network-directed roaming using the BSS Transition Management to trigger roaming). The may be called as roaming in WLAN. During roaming, the STA needs to perform reassociation, security, BA sessions re-establishment, etc. The network performs switching the data path between the gateway and the AP from AP1 to AP2. It is expected that the above roaming steps may cause a delay of 10 ms and packet loss.

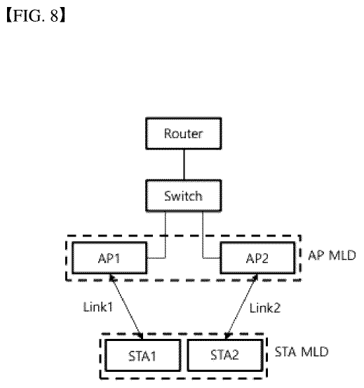

FIG. 8 shows an example of ML operation according to an embodiment of the present disclosure.

Since a STA MLD can support more than one link, more than one AP that are not co-located can be affiliated with an AP MLD. Although AP1 and AP1 are not co-located, AP1 and AP2 can be affiliated with the AP MLD. STA MLD can receive and transmit MSDU or A-MSDU without any service interruption while the STA MLD roams from AP1 to AP2.

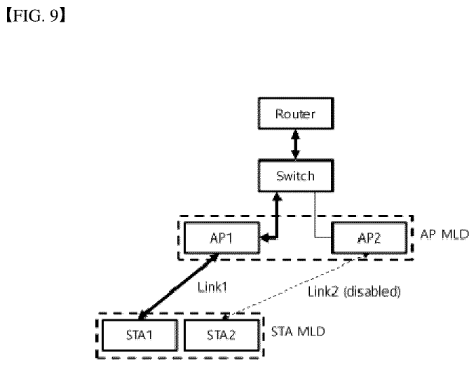

FIG. 9 shows an example of ML operation when an AP is out of range.

A STA MLD establishes the ML setup with an AP MLD. AP1 and AP2 which are affiliated with the AP MLD may not be co-located. When the STA MLD is out of a range of AP2, the link associated with AP1 is enabled but the link associated with AP2 is disabled.

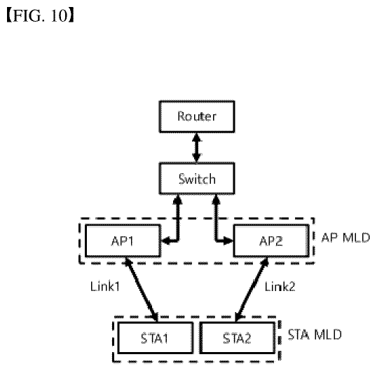

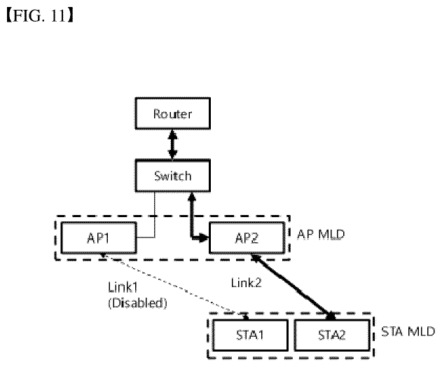

FIG. 10 shows an example of ML operation when the STA MLD moves.

As the STA MLD moves, the STA MLD is in a range of AP1 and AP2 and the links associated with AP1 and AP2 can be enabled again.

FIG. 11 shows an example of ML operation when the STA MLD further moves.

As the STA MLD further moves, the STA MLD is out of a range of AP1. The link associated with AP1 is disabled but the link associated with AP2 is still enabled.

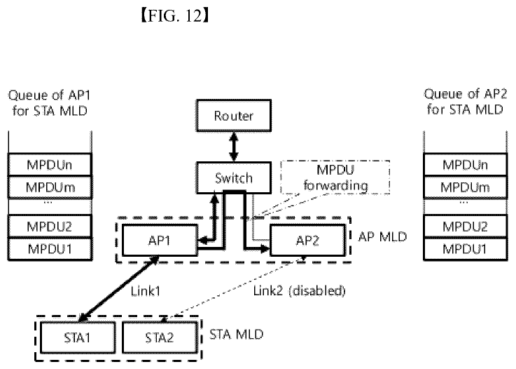

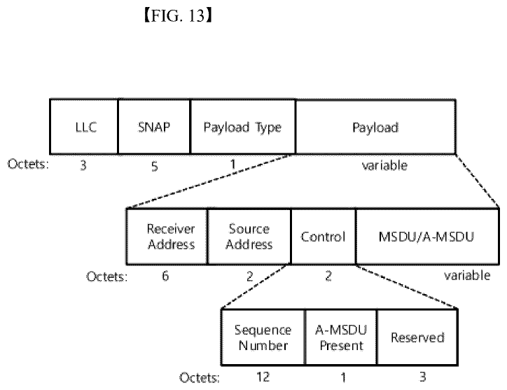

FIG. 12 shows an example of MPDU forwarding during a roaming.

To support a seamless roaming, during the transition period of the STA MLD, AP1 and AP2 needs to store same MPDU contents addressed to/from the STA MLD. For example, when AP1 has pending MPDUs addressed to/from the STA MLD, AP1 cab forward those pending MPDUs to AP2.

In an embodiment, when a STA MLD decides to roam from AP1 to AP2, the STA MLD can send a Seamless Transition (ST) Request frame to AP1. The ST Request frame includes the BSSID of AP2. After receiving the ST Request frame from the STA MLD, AP1 can sends an ST Response frame to the STA MLD as a response to the he ST Request frame. AP1 can start to forward the pending MPDUs addressed to/from the STA MLD to AP2.

When the AP MLD forwards the pending MPDUs from AP1 to AP2, the AP MLD can encapsulate the pending MPDUs in order to carry the MAC header information. When AP1 finishes to forward the pending MPDUs to AP2, AP1 can send an ST Confirm frame to the STA MLD. If the STA MLD is not reachable from AP1, AP1 sends an ST Confirm frame to AP2 through the DS or over the air.

FIG. 13 shows an example of packet format for encapsulated MPDU forwarding. The number of octets for each field is exemplary purpose only.

LLC is defined in ISO/IEC 8802-2:1998. SNAP is defined in IEEE Std 802. The formatting of the SNAP header is according to IETF RFC 1042. The EtherType is set to 89-0d.

A Payload Type field may be set to a specific value (for example, 5) to indicates packet forwarding. For example, when the Payload Type field is set to 5, the Payload field includes a Receiver Address field, a Source Address field, a Control field and MSDU/A-MSDU field.

AP MLD can perform following steps for MPDU forwarding of downlink packet.

(Step 1) AP1 receives a packet from the router via the switch.

(Step 2) AP1 constructs the received packet to the MPDU. The received packet corresponds to the MSDU of the MPDU. The Receiver Address field indicates the MLD MAC address of the STA MLD. The Source Address field indicates the MAC address of the router. The Sequence Number field is assigned from single sequence number space for STA1 and STA2 by the AP MLD. If packets are aggregated into A-MSDU, the A-MSDU Present field is set to a specific value (for example, 1).

(Step 3) After receiving the ST Request frame and responding with the ST Response frame, AP1 encapsulates the MPDU using the EtherType 89-0d frame and sends the encapsulated MPDU to AP2 via the switch.

(Step 4) AP2 will transmit the MPDU to the STA MLD when the link2 is enabled. AP2 has to set the Sequence Number of the MPDU to the Sequence Number value indicated in the Control field in EtherType 89-0d frame.

AP MLD can perform following steps for MPDU forwarding of uplink packet.

(Step 1) AP1 receives a packet from the STA1.

(Step 2) AP1 constructs the received packet to the MPDU. The received packet corresponds to the MSDU of the MPDU. The Receiver Address field indicates the MAC address of the router. The Source Address field indicates the MLD MAC address of the STA MLD. The Sequence Number field is assigned from single sequence number space for AP1 and AP2 by the STA MLD. If packets are aggregated into A-MSDU, the A-MSDU Present field is set to a specific value (for example, 1).

(Step 3) After receiving the ST Request frame and responding with the ST Response frame, AP1 encapsulates the MPDU using the EtherType 89-0d frame and sends the encapsulated MPDU to AP2 via the switch.

(Step 4) AP2 will transmit the MPDU to the router via the switch. AP2 has to reorder the MPDU based on the Sequence Number of the MPDU which is equal to the Sequence Number value indicated in the Control field in EtherType 89-0d frame.

In another embodiment, when a STA MLD decides to roam from AP1 to AP2, the STA MLD can first enable the link associated with AP2. This is referred to as quasi-seamless roaming mode.

The AP MLD updates the Distribution System (DS) mapping for the STA MLD. The DS (e.g., the switch) will deliver packets addressed to/from the STA MLD to AP2. The encapsulation mechanism to forward the MPDUs stored at AP1 to AP2 is not necessary.

The STA MLD sends the ST Request frame to AP1. The ST Request frame includes the BSSID of AP2.

After receiving the ST Request frame from the STA MLD, the AP1 sends the ST Response frame to the STA MLD and it starts to forward the pending MPDUs addressed to/from the STA MLD from AP1 to AP2. Before forwarding the pending MPDUs from AP1 to AP2, the AP1 sends ST Confirm frame to AP2. The ST Confirm frame represents that the pending MPDUs will be forwarded. The ST Confirm frame may include the Sequence Number to indicate the Sequence Number value of the firstly forwarded MPDU. After finishing to forward the pending MPDUs to AP2, the AP1 sends ST Ack frame to AP2. The ST Confirm frame and ST Ack frame can be exchanged through the DS or over the air.

Before processing packets sent from the Router, AP2 that received the ST Confirm frame waits until AP2 receives the ST Ack frame which declares all pending MPDU is forwarded from AP1 to AP2. After receiving the ST Ack frame, AP2 sends pending MPDUs to the STA MLD. The MPDUs that are received from AP1 is first sent. If the ST Confirm frame included the Sequence Number, the MPDU uses the same Sequence Number value. After finishing sending the MPDUs received from AP1, AP2 sends the MPDUs received from the router.

Before processing packets sent to the Router, AP2 that received the ST Confirm frame waits until AP2 receives the ST Ack frame which declares all pending MPDU is forwarded from AP1 to AP2. After receiving the ST Ack frame, AP2 sends pending MPDUs to the router. The MPDUs that are received from AP1 is first sent. If the ST Confirm frame included the Sequence Number, the MPDU uses the same Sequence Number value. After finishing sending the MPDUs received from AP1, AP2 sends the MPDUs received from the STA MLD.

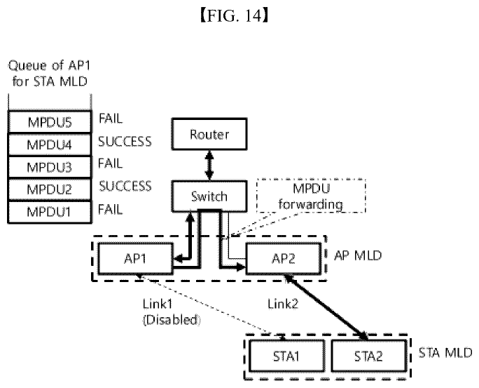

FIG. 14 shows an example of packet loss in quasi-seamless roaming mode. In the quasi-seamless roaming mode, some duplicate transmission and packet loss may be unavoidable.

For example, the MPDU1, MPDU3, MPDU5 were failed but the MPDU2, MPDU4 were successfully transmitted to the STA MLD. If the AP2 transmits all five MPDUs, the STA MLD receives the MPDU2 and MPDU4 redundantly unless the MPDU2 and the MPDU3 has the same Sequence Number value.

In order to reduce duplicate transmission and packet loss, the AP MLD needs to send the pending MPDUs consecutively and provide the reference Sequence Number value to indicate the firstly forward MPDU.

When the AP MLD forwards the pending MPDUs from AP1 to AP2, AP MLD encapsulates the pending MPDUs in order to carry the MAC header information. CCMP header information may also be included if the pending MPDUs are encrypted. CTR with CBC-MAC protocol (CCMP) specifies variants of CCMP, which provides data confidentiality, authentication, integrity, and replay protection. CCMP is based on the CCM of the AES encryption algorithm. CCM combines Counter Mode (CTR) for data confidentiality and CBC-MAC for authentication and integrity. The CCMP Header field is constructed from the PN, ExtIV, and Key ID subfields. A packet number (PN) is a 48-bit PN represented as an array of 6 octets. The PN is incremented by a positive number for each MPDU. In the packet format as shown in FIG. 13, when the Payload Type is set to 5, the Payload field may further include CCMP Header.

Hereinafter, how to discover non-co-located AP MLD is described.

A Reduced Neighbor Report element contains information on neighbor APs, co-located APs, or a combination of both. An AP ALD that intends to report neighboring or co-located APs may include more than one Reduced Neighbor Report element in a Beacon frame, Probe Response frame, or FILS Discovery frame.

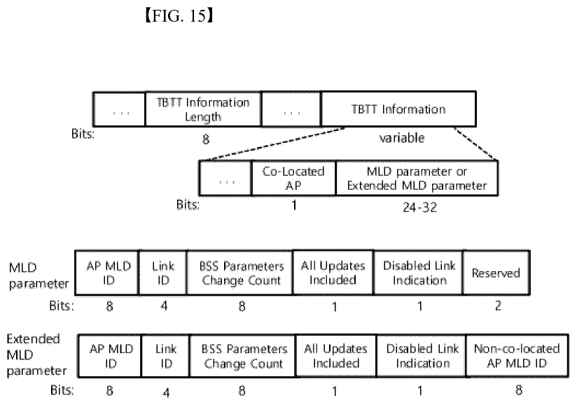

FIG. 15 shows an example of Reduced Neighbor Report element format according to an embodiment of the present disclosure. Names of fields and the number of bits for each field are exemplary purpose only. Not all fields are essential.

Contents of a target beacon transmission time (TBTT) information field depends on the interpretation of a TBTT Information Length field. When the TBTT Information Length field is set to a first value (e.g. 16), the TBTT information field includes an MLD parameter to indicate co-located AP affiliated with the AP MLD. When the TBTT Information Length field is set to a second value (e.g. 17), the TBTT information field includes an Extended MLD parameter to indicate non-co-located AP affiliated with the AP MLD.

The Co-Located AP subfield may be set to 1 if every AP in this element is in the same co-located AP set as the transmitting AP. It is set to 0 otherwise.

The MLD parameter for co-located AP affiliated with the AP MLD includes an AP MLD ID subfield, a Link ID subfield, a BSS Parameters Change Count subfield, an All Updates Included subfield and a Disabled Link Indication subfield. The AP MLD ID subfield indicates the identifier of the AP MLD with which the reported AP is affiliated. The Link ID subfield indicates the link identifier of the reported AP within the AP MLD with which the reported AP is affiliated. The BSS Parameters Change Count subfield is an unsigned integer, initialized to 0, that increments when a critical update to the BSS Parameters of the reported AP occurs. The All Updates Included subfield indicates if the updated elements that correspond to the latest critical update that generated a change to the value carried in the BSS Parameters Change Count subfield for the reported AP are included in the frame carrying the Reduced Neighbor Report element. The All Updates Included subfield is set to 1 if all the updated elements are included and set to 0 otherwise. The Disabled Link Indication subfield may indicate that the reported AP is operating on a link that is advertised as disabled for all associated non-AP MLDs and the reported AP is affiliated with the same AP MLD as the reporting AP.

The Extended MLD parameter for non-co-located AP affiliated with the AP MLD further includes a non-co-located AP MLD ID subfield. For the backward compatibility, the AP MLD ID subfield may be set to 255. The AP MLD ID subfield is set to 255 if the reported AP is not part of an AP MLD, or if the reporting AP does not have information of that MLD. The Non-collocated AP MLD ID subfield may be set to the same value as the AP MLD ID subfield for the co-located AP. For example, if the AP MLD ID subfield for co-located AP is set to ‘x’, the non-co-located AP MLD ID subfield for non-co-located AP may also be set to ‘x’.

To distinguish between a co-located AP affiliated with the AP MLD and a nonco-located AP affiliated with the AP MLD, for a co-located AP affiliated with the AP MLD, the Co-Located AP subfield may be set to a value (for example, 0). The Co-Located AP subfield may be is set to a value (for example, 1) if every AP in this Neighbor AP Information field is in the same co-located AP set as the transmitting AP. For a non-collocated AP affiliated with the AP MLD, the Co-Located AP subfield may be set to a value (for example, 1).

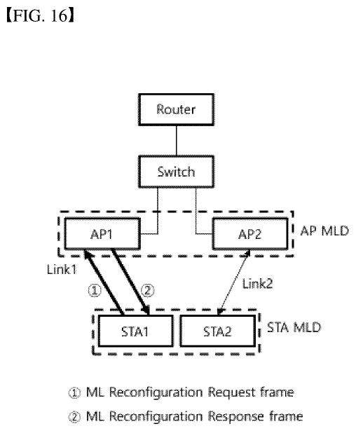

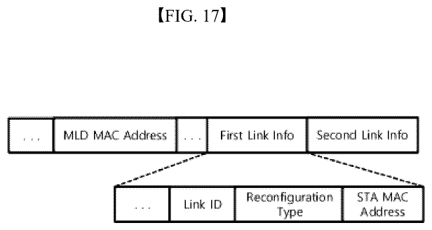

FIG. 16 shows an example of ML reconfiguration according to an embodiment of the present disclosure.

The ML setup procedure sets up link(s) between a non-AP MLD and an AP MLD and may be completed through the exchange of Association Request and Association Response frames. The ML reconfiguration may define procedure for adding and deleting links dynamically to the ML setup of a non-AP MLD without requiring (re) association between the peer MLDs and for AP MLD to recommend ML reconfiguration to the ML setup of its associated non-AP MLD(s). The ML reconfiguration may be used for adding and deleting links dynamically without requiring (re) association between AP MLD and non-AP MLD.

As the STA MLD moves, the STA MLD may decide to use the link which is served by the non-co-located AP affiliated with the AP MLD. In which case, the STA MLD can request to reconfigure the multi-link setup for adding a new link and removing an existing link if needed. The STA MLD can send the ML Reconfiguration Request frame to the AP MLD. The AP MLD can respond the ML Reconfiguration Response frame to the STA MLD.

ML Reconfiguration Request frame may be sent through an enabled link. ML Reconfiguration Request frame may indicate one of two types: ‘Add Link’ or ‘Switch Link’. ML reconfiguration request frame can requests add link or switch link. The ML reconfiguration request frame indicating switch link may be used to request switching from a second AP affiliated with the AP MLD operating on a second link to be added to a first AP affiliated with the AP MLD operating on a first link to be deleted.

If ML Reconfiguration Request frame indicates Add Link, ML Reconfiguration Request frame may contain link ID information that is requested to be added. In the example shown in FIG. 16, the link ID for the Link 2 is included in the ML Reconfiguration Request frame. ML Reconfiguration Response frame may indicate whether the requested link is successfully added or not. The AP MLD can allocate an AID to the STA MLD for the operation with the non-co-located AP (AP2).

If ML Reconfiguration Request frame indicates Switch Link, ML Reconfiguration Request frame may contain first link ID information that is requested to be added and second link ID information that is requested to be deleted. In the example shown in FIG. 16, Link 2 is the link to be added and Link 1 is the link to be removed. First link ID information indicating Link 1 and second link ID information indicating Link 2 can be included in the ML Reconfiguration Request frame.

The AP MLD can transmit ML Reconfiguration Response frame in response to the ML Reconfiguration Request frame. ML Reconfiguration Response frame indicates whether links are successfully switched (whether both link removal and link addition are successfully processed). The AP MLD can allocate an AID to the STA MLD for the operation with the non-co-located AP (AP2).

Switch Link can be useful when the supported link is limited. For example, a non-AP MLD that supports two links operates on the 2.4 GHz and 5 GHz. When AP MLD adds another link on 6 GHz, the non-AP MLD can request to switch 2.4 GHz link to 6 GHz link. If Switch Link is not supported, the non-AP MLD first adds 6 GHz link and then removes 2.4 GHz link. This requires additional resources (e.g., one more STA MAC Address) for STA MLD and the removal of 2.4 GHz link may not be guaranteed.

FIG. 17 shows an example of ML Reconfiguration Request frame according to an embodiment of the present disclosure.

An ML Reconfiguration Request frame can include an MLD MAC address field and at least one Link Info field for each affiliated non-AP STA that the non-AP MLD is requesting to add to its ML setup or delete from its ML setup. When the ML Reconfiguration Request frame includes one Link Info field indicating adding link, the ML Reconfiguration Request frame indicates Add Link. When the ML Reconfiguration Request frame includes two Link Info fields indicating adding link and deleting link, the ML Reconfiguration Request frame can indicate Switch Link.

The MLD MAC Address field can be set to the MAC Address of the non-AP MLD that transmits the ML Reconfiguration Request frame.

When the First Link Info field indicates adding link, a Link ID subfield can set to the link identifier of the AP affiliated with the associated AP MLD that is operating on the link that the non-AP MLD is requesting to add. A Reconfiguration Type subfield indicates that a type of the reconfiguration is adding link. A STA MAC Address subfield can be set to the STA MAC address of the non-AP STA that is indicated for operation on the link requested to be added with the AP indicated by the link ID.

When the Second Link Info field indicates deleting an existing link, a Link ID subfield can be set to the link identifier of the AP affiliated with the AP MLD that is operating on the link that is requested to be deleted from the ML setup. A Reconfiguration Type subfield indicates that a type of the reconfiguration is deleting link. A STA MAC Address subfield can be set to the STA MAC address of the non-AP STA operating on the link indicated by the link ID, which is requested to be deleted.

When the non-STA MLD wants to switch the link for a non-AP STA to another affiliated AP, the STA MAC address of the First Link Info field indicating adding link and the STA MAC address of the Second Link Info field indicating deleting link can be set to same value for the non-AP STA.

An AP MLD can send the ML Reconfiguration Response frame on the same link where the corresponding ML Reconfiguration Request frame was received.

After receiving the ML Reconfiguration Request frame from a non-AP MLD, the AP MLD can respond with a ML Reconfiguration Response frame. If the AP MLD receives the ML Reconfiguration Request frame that indicates both delete link and add link for the same non-AP STA identified by the same STA MAC Address value in the First and Second Link Info fields for delete and add link operations, then the AP MLD can process the delete link operation first for that non-AP STA.

The AP MLD may allocate one or more AID to a non-AP MLD, and send the allocated AID to the non-AP MLD through (Re) Association Response and/or ML Reconfiguration Response frames.

For example, first AP and second AP are affiliated with the AP MLD but are not co-located. A first AID is allocated to the non-AP MLD for communication with the first AP affiliated with the AP MLD. A second AID is allocated to the non-AP MLD for communication with the second AP affiliated with the AP MLD. When the first AP affiliated with the AP MLD sends a Trigger frame (and/or DL MU PPDU) to the non-AP MLD, the first AID is used to identify the non-AP MLD. When the second AP affiliated with the AP MLD sends a Trigger frame (and/or DL MU PPDU) to the non-AP MLD, the second AID is used to identify the non-AP MLD.

After enabling a link with a newly roamed AP, a non-AP MLD can provide the BA information to the roamed AP, to synchronize the BA status between the roamed AP (that is a non-co-located AP affiliated with the AP MLD) and a non-AP MLD. On this purpose, a newly roamed AP can send the BlockAckReq frame (and/or MU-BAR Trigger frame) to solicit the BA information from the non-AP MLD. When the BlockAckReq frame is used to synchronize the BA status, the Unsolicited BA subfield in the BAR Control field in the BlockAckReq frame is set to 1. In such case, the Block Ack Starting Sequence Control subfield in BAR Information field in the BlockAckReq frame is reserved. After receiving the BlockAckReq frame having the Unsolicited BA subfield in the BAR Control field set to 1, the non-AP MLD provides the BA information based on its own Starting Sequence Number. (Receiver decides the Block Ack Bitmap in the BA). Alternatively, the non-AP MLD may send the BA information in the unsolicited Compressed BlockAck frame.

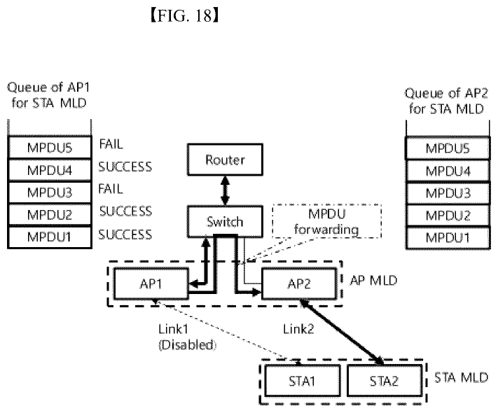

FIG. 18 shows an example of ML setup procedure.

The STA2 affiliated with the STA MLD enables the link 2. The AP2 affiliated with the AP MLD sends the BlockAckReq frame (and/or MU-BAR Trigger frame) to update the BA information of the STA. The AP1 can also forward the BA related parameters to the AP2. However, since the BA related parameter is dynamically changed, it is not possible to maintain the completely synchronized status.

For example, the MPDU1 and MPDU2 were already delivered through the STA1 affiliated with the STA MLD. AP2 can discard those MPDUs. In order to determine the MPDUs that is required to deliver to the STA MLD, the AP2 affiliated with the AP MLD sends the BlockAckReq frame and the STA2 affiliated with the STA MLD sends the BA information. In such case, the Starting Sequence Number subfield of the Block Ack Starting Sequence Control subfield may not be specified and is reserved.

The STA2 can provide the BA information for MPDUs to request independent of the Starting Sequence Number in the BlockAckReq frame/MU-BAR Trigger frame. Usually, the originator contains the sequence number of the first MSDU or A-MSDU for which this BlockAckReq frame is sent. In the example shown in FIG. 18, STA2 provides the BA information for MPDU3, 4, and 5.

The Block Ack Bitmap subfield of the BA Information field of the Compressed BlockAck frame (and/or Multi-STA BlockAck frame) indicates the receive status. Each bit that is equal to 1 in the compressed Block Ack Bitmap subfield indicates the reception or discard (depending on the latency, the receiver may indicates the discard) of a single MSDU or A-MSDU in the order of sequence number, with the first bit of the Block Ack Bitmap subfield corresponding to the MSDU (or fragment thereof) or A-MSDU (or fragment thereof) with the sequence number that matches the Starting Sequence Number subfield of the Block Ack Starting Sequence Control subfield.

Each bit that is equal to 0 in the compressed Block Ack Bitmap subfield indicates a transmission request of a single MSDU or A-MSDU in the order of sequence number, with the first bit of the Block Ack Bitmap subfield corresponding to the MSDU (or fragment thereof) or A-MSDU (or fragment thereof) with the sequence number that matches the Starting Sequence Number subfield of the Block Ack Starting Sequence Control subfield.

A newly roamed AP may need to adjust the Block Ack Parameter Set (e.g., Buffer Size). In such case, the roamed AP may indicate to the non-AP MLD the Block Ack (BA) agreement has to be re-established. The ML Reconfiguration Response frame may signal that the BA agreement re-establishment is required. Additionally, the timeout information of the BA agreement re-establishment can be signaled. After the timeout is expired, if the non-AP MLD has not re-establish the BA agreement, current BA agreement can't be maintained with the roamed AP.

After receiving the signal that represents the BA agreement re-establishment is required, the non-AP MLD should send the ADDBA Request frame if it wants to keep the Block Ack procedure. In a response of the ADDBA Request frame, the AP MLD will send the ADDBA Response frame for the updated BA agreement. Alternatively, the AP MLD can send the unsolicited ADDBA Response frame for the updated BA agreement.

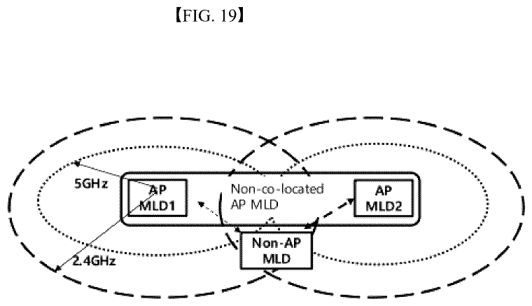

FIG. 19 shows an example of non-co-located AP MLD.

Although an AP MLD1 and AP MLD2 are not co-located, they can consist of a virtual MLD. It is called as a non-co-located AP MLD. Each of AP MLD1 and AP MLD2 can serve as a non-AP MLD.

The non-co-located AP MLD can serve the seamless roaming for the non-AP MLD. The non-AP MLD that is associated with the non-co-located AP MLD is not needed to establish the ML setup with each of AP MLD1 and AP MLD2. The non-AP MLD can dynamically add or delete links associated with the AP MLD1 and AP MLD2 as described in above embodiments.

A non-AP MLD may establish the ML setup with the non-co-located AP MLD. Initially, the non-AP MLD has setup links associated with the AP MLD1. As moving away from the AP MLD1's service coverage, the non-AP MLD can add other link associated with the AP MLD2.

Hereinafter, ML seamless roaming procedure is proposed. AP MLD1 is called as a serving AP MLD (or a source AP MLD) and AP MLD 2 is called as a roaming AP MLD (or a target AP MLD).

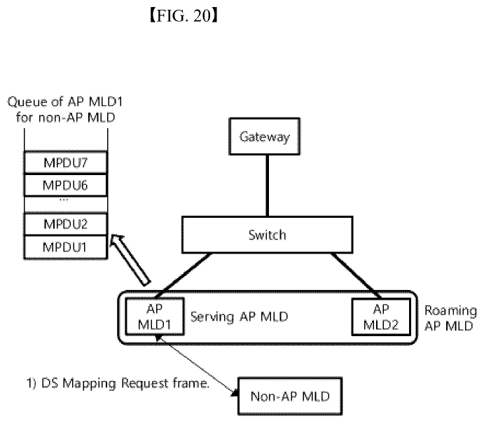

FIG. 20 shows first step for ML roaming procedure according to an embodiment of the present disclosure.

First, a non-AP MLD sends a distribution system (DS) Mapping Request frame to a serving AP MLD. AP MLD1 can stop to forward uplink packets to gateway, but can continue to send downlink packets to non-AP MLD.

An Update Type field of the DS Mapping Request frame can be set to ‘DELETE’ or ‘MOVE’. The Update Type field specifies the DS mapping update operation to be performed.

When the Update Type field indicates ‘DELETE’, the serving AP MLD issues the DS-STA-NOTIFY.request primitive to delete DS's STA-to-AP mapping after receiving the DS Mapping Request frame. The serving AP MLD does not respond to the ARP Request frame associated with the non-AP MLD, because the DS mapping is deleted (e.g., the proxy ARP service is disabled).

When the Update Type field indicates ‘DELETE’, the serving AP MLD can send the uplink DATA packets to the DS, except when the non-AP MLD indicates in the DS Mapping Request frame that the serving AP MLD stops to forward the uplink DATA packet to the DS. The serving AP MLD that sends the uplink DATA packets to the DS can set the Source MAC Address field of the Ethernet frame to the AP MLD's MAC address (or MAC address associated with DS interface of the AP MLD). Otherwise, the serving AP MLD can send it to the DS through other encapsulation mechanism to not reveal the STA's MLD MAC address from the Source MAC Address field of the Ethernet frame.

When the Update Type field indicates ‘DELETE’, the serving AP MLD can send the downlink DATA packets to the non-AP MLD unless all setup links between the non-AP MLD and the serving AP MLD are removed. The non-AP MLD cannot send uplink DATA packets to the serving AP MLD.

When the Update Type field indicates ‘MOVE’, the serving AP MLD and the non-AP MLD can follow the same procedure as that the Update Type field indicates DELETE. However, the serving AP MLD can send MOVE-Notify frame to the roaming AP MLD. After receiving the MOVE-Notify frame, the roaming AP MLD issues the DSSTA-NOTIFY.request primitive to add DS's STA-to-AP mapping. The roaming AP MLD sends the L2 Update frame (e.g., XID frame). Source MAC Address field of XID frame is set to the STA MLD MAC address. Destination MAC Address field of XID frame is set to the broadcast MAC address.

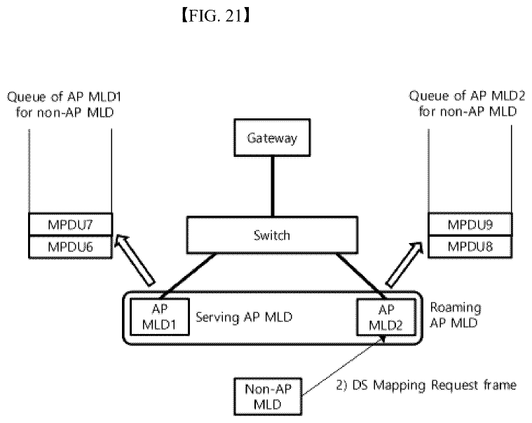

FIG. 21 shows second step for ML roaming procedure according to an embodiment of the present disclosure.

After the non-AP MLD sends a DS Mapping Request frame to a serving AP MLD, the non-AP MLD sends a DS Mapping Request frame to a roaming AP MLD. AP MLD2 can update DS's STA-to-AP mapping by sending XID frame to switch. Gateway can send downlink packets to non-AP MLD. AP MLD1 optionally sends downlink packets to non-AP MLD.

The Update Type field of the DS Mapping Request frame can be set to ADD. The roaming AP MLD issues the DS-STA-NOTIFY.request primitive to add DS's STA-to-AP mapping after receiving the DS Mapping Request frame. The roaming AP MLD sends the L2 Update frame (e.g., XID frame). Source MAC Address field of XID frame is set to the STA MLD MAC address. Destination MAC Address field of XID frame is set to the broadcast MAC address.

Since the DS Mapping of the non-AP MLD is changed to the roaming AP MLD, the downlink DATA packets can be forwarded from DS to the roaming AP MLD.

The roaming AP MLD may send the downlink DATA packets to the non-AP MLD according to the following rules. If the non-AP MLD needs to receive the downlink DATA packets which are buffered at the serving AP MLD, the non-AP MLD can enter the power management mode for the roaming AP MLD. Or the non-AP MLD can explicitly signal in the DS Mapping Request frame to pause the downlink DATA packet transmission addressed to the non-AP MLD. In consequence, the roaming AP MLD does not send the downlink DATA packets to the non-AP MLD.

The non-AP MLD can send the uplink DATA packets to the roaming AP MLD. The roaming AP MLD can send the uplink DATA packets to the DS unless the non-AP MLD explicitly signaled in the DS Mapping Request frame to pause the uplink DATA packet transmission to the DS.

If the non-AP MLD has the uplink DATA packets which are buffered at the serving AP MLD, the non-AP MLD can signal that the roaming AP MLD pauses the uplink DATA packet transmission to the DS.

In such case, after flushing all pending uplink DATA packets at the serving AP MLD, the non-AP MLD can send another DS Mapping Request frame to the roaming AP MLD in order to activate the uplink DATA packet transmission to the DS.

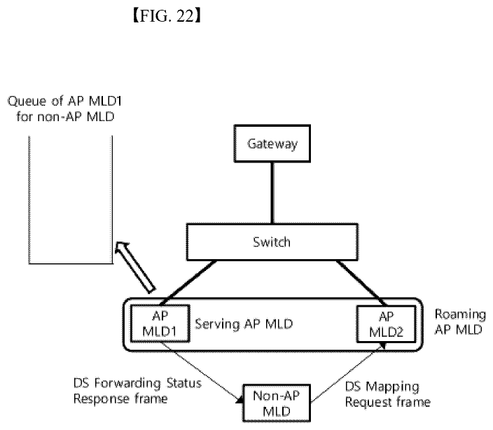

FIG. 22 shows third step for ML roaming procedure according to an embodiment of the present disclosure.

A non-AP MLD can send a DS Forwarding Status Request frame to know the DS forwarding status at the serving AP MLD. The serving AP MLD sends a DS Forwarding Status Response frame to the non-AP MLD after receiving the DS Forwarding Status Request frame. The DS Forwarding Status Response frame indicates the number of DATA packets (or MSDUs) which are pending to be forwarded from the DS to the non-AP MLD or from the non-AP MLD to the DS.

The serving AP MLD can send a DS Forwarding Status Response frame to the non-AP MLD when the serving AP MLD has no pending DATA packet to be forwarded from the DS to the non-AP MLD or from the non-AP MLD to the DS.

The non-AP MLD can send DS Mapping Request frame to the roaming AP MLD. AP MLD2 and AP MLD1 can send downlink packets to non-AP MLD and uplink packets to gateway.

Hereinafter, group-addressed frame delivery in ML seamless roaming is described.

When a non-AP MLD switches from its serving AP MLD to a roaming AP MLD, the non-AP MLD needs to avoid receiving duplicated group-addressed frames. On this purpose, the serving AP MLD and the roaming AP MLD uses the same Sequence Number space for the group-addressed transmission.

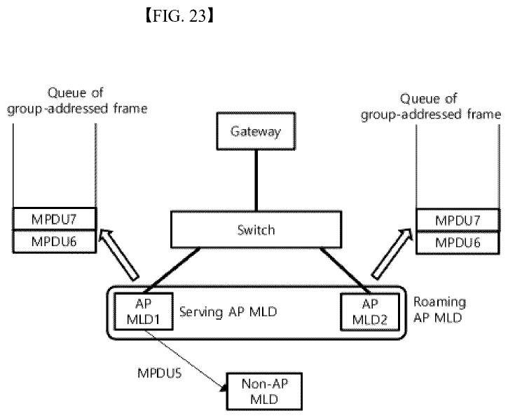

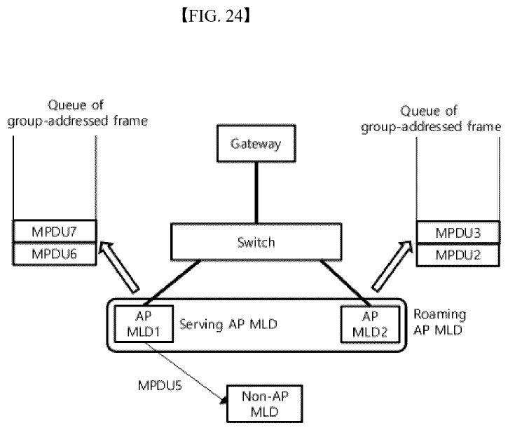

FIG. 23 shows first example of group-addressed frame delivery according to an embodiment of the present disclosure.

AP MLD1 and AP MLD2 can assign the same Sequence Number for the group-addressed MPDUs. The roaming AP MLD does not transmit the group-addressed frame if no STA associated with the roaming AP is a member of a specific multicast group. But, even if the roaming AP MLD does not transmit the group-addressed frame, the roaming AP MLD can maintain a single Sequence Number space. When the non-AP MLD sends a DS Mapping Request frame to the roaming AP MLD to indicate a switch, the roaming AP MLD can deliver the group-addressed frame to the non-AP MLD.

However, this approach may not work in certain scenarios. For instance, if no STA associated with the roaming AP belongs to a specific multicast group, the DS doesn't send the corresponding group-addressed frame to the roaming AP. Maintaining synchronous sequence number assignment among AP MLDs can be challenging.

As alternative solution, once the DS mapping for the non-AP MLD switches to the roaming AP MLD, both the serving AP MLD and the roaming AP MLD may provide the non-AP MLD with the Sequence Number of the latest group-addressed frame they received from the DS. The non-AP MLD discards the group-addressed frame from the serving AP MLD if its Sequence Number is greater than the Sequence Number provided. The non-AP MLD discards the group-addressed frame from the roaming AP MLD if its Sequence Number is less than or equal to the Sequence Number provided.

FIG. 24 shows second example of group-addressed frame delivery according to an embodiment of the present disclosure.

The non-AP MLD receives MPDU5, MPDU6 and MPDU7 from the serving AP MLD (i.e., Queue is empty). Then, the non-AP MLD sends a DS Mapping Request frame to the roaming AP MLD to indicate a switch.

The roaming AP MLD replies with the DS Mapping Response frame, which includes Sequence Number 3 as the latest Sequence Number. This represents the last sequence number of the frame buffered at the roaming AP MLD before the non-AP MLD switches to the roaming AP MLD. In other words, the roaming AP MLD's the latest group-addressed frame received before the DS Mapping Request frame from the non-AP MLD.

The non-AP MLD discards the group-addressed frame whose Sequence Number field is less than or equal to the latest Sequence Number provided by the roaming AP MLD through the DS Mapping Response frame.

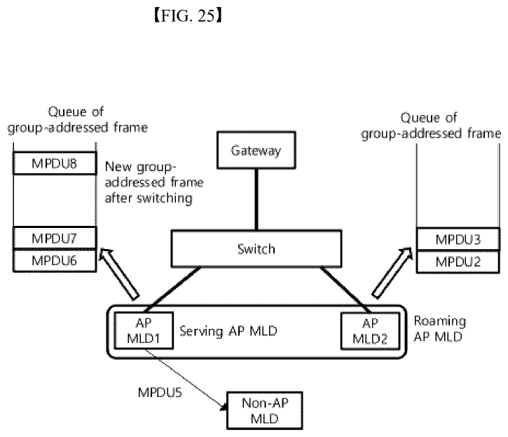

FIG. 25 shows third example of group-addressed frame delivery according to an embodiment of the present disclosure.

Once the DS mapping for the non-AP MLD switches to the roaming AP MLD, a non-AP MLD sends a DS Mapping Request frame to the serving AP MLD.

The serving AP MLD replies with the DS Mapping Response frame, which includes Sequence Number 7 as the latest Sequence Number. This represents the last sequence number of the frame buffered at the serving AP MLD before the non-AP MLD switches to the roaming AP MLD. In other words, the serving AP MLD's the latest group-addressed frame received before the DS Mapping Request frame from the non-AP MLD.

The non-AP MLD discards the group-addressed frame whose Sequence Number field is greater than the latest Sequence Number provided by the serving AP MLD through the DS Mapping Response frame.

As used herein, a phrase referring to “at least one of” or “one or more of” a list of items refers to any combination of those item, including single members. For example, “at least one of: a, b, and c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

While operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

1. A method for reconfiguring multi-link (ML) to add and delete links dynamically without requiring association between an access point (AP) multi-link device (MLD) and a non-AP MLD in a wireless local area network, the method performed by the non-AP MLD and comprising:
transmitting a ML reconfiguration request frame for requesting switch link from a non-AP station (STA) affiliated with the non-AP MLD to an AP affiliated with the AP MLD; and
receiving a ML reconfiguration response frame from the AP MLD in response to the ML reconfiguration request frame,
wherein the ML reconfiguration request frame includes first link information indicating a first link that is requested to be added and second link information indicating a second link that is requested to be deleted.

2. The method of claim 1, wherein:
the first link information includes a link ID subfield and a reconfiguration type subfield, the link ID subfield indicating the first link that is requested to be added, the reconfiguration type subfield indicating adding link, and
the second link information includes a link ID subfield and a reconfiguration type subfield, the link ID subfield indicating the second link that is requested to be deleted, the reconfiguration type subfield indicating deleting link.

3. The method of claim 2, wherein the first link information further includes a station address subfield indicating the non-AP STA affiliated with the non-AP MLD, and the second link information further includes a station address subfield indicating the non-AP STA affiliated with the non-AP MLD.

4. The method of claim 1, wherein the ML reconfiguration response frame is received on a same link where the ML reconfiguration request frame is transmitted.

5. The method of claim 1, wherein the ML reconfiguration request frame is used to request switching from a second AP affiliated with the AP MLD operating on the second link to a first AP affiliated with the AP MLD operating on the first link.

6. A device operating as a non-access point (AP) multi-link device (MLD) for reconfiguring multi-link (ML) to add and delete links dynamically without requiring association between an AP MLD and the non-AP MLD in a wireless local area network, the device comprising:
a processor; and
a memory operatively coupled with the processor and configured to store instructions that, when executed by the processor, cause the device to perform functions comprising:
transmitting a ML reconfiguration request frame for requesting switch link from a non-AP station (STA) affiliated with the non-AP MLD to an AP affiliated with the AP MLD; and
receiving a ML reconfiguration response frame from the AP MLD in response to the ML reconfiguration request frame,
wherein the ML reconfiguration request frame includes first link information indicating a first link that is requested to be added and second link information indicating a second link that is requested to be deleted.

7. The device of claim 6, wherein:
the first link information includes a link ID subfield and a reconfiguration type subfield, the link ID subfield indicating the first link that is requested to be added, the reconfiguration type subfield indicating adding link, and
the second link information includes a link ID subfield and a reconfiguration type subfield, the link ID subfield indicating the second link that is requested to be deleted, the reconfiguration type subfield indicating deleting link.

8. The device of claim 7, wherein the first link information further includes a station address subfield indicating the non-AP STA affiliated with the non-AP MLD, and the second link information further includes a station address subfield indicating the non-AP STA affiliated with the non-AP MLD.

9. The device of claim 6, wherein the ML reconfiguration response frame is received on a same link where the ML reconfiguration request frame is transmitted.

10. The device of claim 6, wherein the ML reconfiguration request frame is used to request switching from a second AP affiliated with the AP MLD operating on the second link to a first AP affiliated with the AP MLD operating on the first link.
